(19) United States
(12) Patent Application Publication
(10) Pub. No.: US 2007/0024425 A1
(43) Pub. Date: Feb. 1, 2007

(54) Active capacitive coupling RFID device, system and method of production thereof

(76) Inventors: Zvi Nitzan, Zofit (IL); Doron Lavee, Karmel Yosuf (IL); Yoram Karmon, Petach Tikvah (IL)

Correspondence Address: KENYON & KENYON LLP, 1500 K STREET N.W., SUITE 700, WASHINGTON, DC, 20005, US

(21) Appl. No.: 11/495,556

(22) Filed: Jul. 31, 2006

Related U.S. Application Data
(60) Provisional application No. 60/703,876, filed on Aug. 1, 2005.

(51) Int. Cl. H04Q 5/22

(52) U.S. Cl. 340/10.1; 340/572.1

(57) ABSTRACT

The present invention is of an active RFID system configured for SIMPLEX two way communication based on conductive coupling, wherein two way communication is non-simultaneous and can operate on a single frequency comprising at least one capacitive coupling reader, wherein the reader is configured to transmit modulated or unmodulated RF electric signals and to receive and decode data transmitted by the transponder; at least one active capacitive coupling RFID transponder comprising at least one integrated circuit, which is arranged to store a code comprising information and which is configured for capacitive coupled RFID transponder application; at least one antenna configured to receive signal from the at least one reader, and transmit the transponder code comprising information; and at least one power source for providing energy to operate the at least one integrated circuit and transponder transmission; and at least one data processing device for processing the data received from the reader. The fully active transponder includes a carrier frequency control circuit wherein the carrier frequency generator is configured to facilitate correction of frequency error in comparison to the reader transmitter carrier frequency.

This application claims priority to U.S. Provisional Application Ser. No. 60/703,876, filed Aug. 1, 2005 and incorporated by reference herein in its entirety.

### FIELD OF THE INVENTION

The present invention relates in general to a radio frequency identification device and system, and in particular to an active capacitive coupling radio frequency identification device, system, and a method of production thereof.

### BACKGROUND OF THE INVENTION

A typical RFID system includes an RFID transponder (tag or a label), a reader and data processing equipment, such as a computer. Data transfer from/to the RFID transponder (tag or label) and the processing equipment is routed via the air interface between the reader and the RFID transponder, via the reader using for example RF TEM (Transverse Electro-Magnetic) wave, by inductive coupling and by capacitive coupling.

Conventional LF (low frequency) and HF (high frequency) RFID is based on inductive coupling technology. An inherent disadvantage of inductive coupling is the high cost of component mounting and expensive antenna coil material. Therefore, the resulting inductive coupling RFID transponder tags are relatively costly. Further, inductive tags are susceptible to mechanical damage, but require a fully intact coil to function. A torn or cut inductive tag results in a fully disabled tag. These problems can be overcome by using capacitive coupling communication technology. Passive RFID labels based on capacitive coupling generally include a low cost carbon ink antenna and low cost component assembly, resulting in cheaper RFID labels. Such a capacitive coupling label offers the advantage of functioning even when it is partially damaged.

However, the read range of passive RFID capacitive coupling labels described in the art is relatively limited. This is due to a number of factors, which include reader receiver desensitization caused by a high voltage reader transmitter, poor reader modulation efficiency by the transponder and limited area available for the transponder antenna. It would therefore be beneficial to have a capacitive coupling tag with an i The present invention provides such a transponder and system, comprising an active transponder based on capacitive coupling, which is configured for two-way communication wherein transponder to reader and reader to transponder communication is not simultaneous.

### BRIEF DESCRIPTION OF DRAWINGS

FIG. 1 is a schematic representation of an active RFID system based on capacitive coupling according to an embodiment of the present invention;

FIGS. 2a,b,c are exemplary schematic representations of active RFID transponders according to embodiments of the present invention;

FIG. 3 is a schematic representation of an embodiment of an active RFID transponder based on capacitive coupling according to the present invention;

FIG. 4 is a schematic representation of an alternative embodiment of an active RFID transponder based on capacitive coupling according to the present invention;

FIG. 5 is a schematic representation of an exemplary power source according to an embodiment of the present invention;

FIG. 6 is an exemplary schematic representation of an active RFID device based on capacitive coupling with an integrated power source and antenna according to one embodiment of the present invention;

FIGS. 7a, b, c are flow diagrams of production procedures of an active RFID label transponder device based on capacitive coupling according to embodiments of the present invention; and

FIG. 8 is a time diagram of a reader cycle according to an embodiment of the present invention.

### DETAILED DESCRIPTION

Embodiments of the present invention provide an active RFID system based on capacitive coupling. One embodiment of the system includes at least one active RFID transponder based on capacitive coupling, at least one reader designed or configured for capacitive coupling and at least one data processing device. Optionally, an active RFID system based on capacitive coupling may include a plurality of transponders based on capacitive coupling and a plurality of readers and a plurality of data processing devices. In some embodiments, the reader can read the data transmitted from the active transponder based on capacitive coupling and transfer the data to at least one data processing device. In some embodiments, the data processing device is configured to process data from the reader. In some embodiments, the system is configured for SIMPLEX two-way communication, wherein two way communication is not simultaneous and wherein the SIMPLEX communication link may operate on a single frequency.

The term “transponder” as used herein includes, but is not limited to tags, labels, stickers, wristbands, smart cards, disks or coins, glass transponders, plastic housing transponders, watch face transponders and any combination thereof. The term includes a transponder comprising an IC, a power source and an antenna disposed on a substrate base layer. The term also includes a transponder, which comprises at least one antenna coupled to a powerposer, wherein the powerposer includes an interposer, and at least one power source and at least one IC disposed thereon. As used herein the term “powerposer” refers to an interposer which is configured for ready attachment to at least one antenna or a label substrate, and at least one power source and electronic circuitry (at least one IC) configured for active RFID transponder application based on capacitive coupling, and wherein the power source and electronic circuitry can be disposed on the interposer substrate. The term “transponder” includes any size, thickness, shape, and form of transponder device. The term includes integrated and non-integrated devices, such as, but not limited to, devices integrated into the packaging of an object or integrated into the object or product itself. The term includes transponders, which are fully printed, semi printed or made by any other suitable technology.

In some embodiments, the active RFID transponder device based on capacitive coupling includes at least one power source, electronic circuitry configured for active RFID transponder application based on capacitive coupling, and at least one antenna, which can be disposed on a suitable substrate base layer of the label or on the object to be tracked. In some embodiments, electronic circuitry configured for active RFID transponder application is at least one integrated circuit (IC) chip. In some embodiments, the IC chip is an application specific integrated circuit (ASIC). Optionally, the active RFID transponder device can include any combination of one or a plurality of power source, integrated circuit chip and antenna disposed on at least one suitable substrate base layer. Optionally, the antenna can be made from any suitable conductive material. In some embodiments, the antenna is a carbon antenna.

In some embodiments, the active transponder includes at least one antenna and at least one powerposer device. In such an embodiment, the at least one antenna is not disposed on the interposer substrate, but may be disposed directly on the object or packaging of the object to be tracked. The powerposer may be connected to the antenna by any suitable means such as with conductive adhesive.

In some embodiments, the active transponder device configured for capacitive coupling features a printed battery and a printed antenna. In some embodiments the transponder device based on capacitive coupling features a printed antenna, wherein the antenna or part of the antenna is configured as part of the battery. In a further embodiment, the present invention provides a partially or fully printable active RFID transponder device based on capacitive coupling, wherein at least one of or all of the battery, antenna and electronic circuitry configured for RFID transponder application based on capacitive coupling are printed in any suitable way on at least one substrate base layer.

Embodiments of the present invention also provide means for conserving energy of the power source.

Before explaining at least one embodiment of the invention in detail, it is to be understood that the invention is not limited in this application to the details of construction and the arrangement of the components set forth in the following description or illustrated in the drawings. The inventions are applicable to other embodiments or of being practiced or carried out in various ways. Also, it is to be understood that the phraseology and terminology employed herein is for the purpose of description and should not be regarded as limiting.

1.0 System

The principles and operation of an active RFID device and system based on capacitive coupling according to the present invention may be better understood with reference to the drawings and accompanying descriptions.

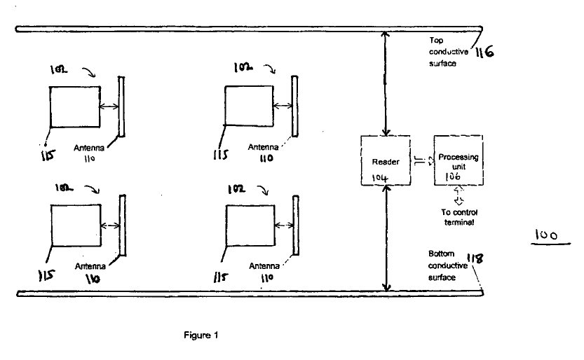

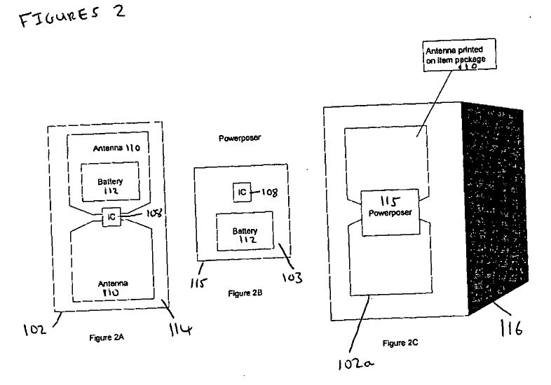

FIG. 1 is a schematic representation of one embodiment of an active capacitive coupling RFID system 100 according to the present invention. As can be seen from FIG. 1, RFID system based on capacitive coupling 100 may include at least one active capacitive transponder 102, at least one reader 104 and at least one data processing unit 106. In some embodiments, as shown in the example of FIG. 1, RFID system configured for capacitive coupling 100 may include a plurality of active capacitive transponders 102. Active transponder 102 may be attached to a package (not shown in figure) using any suitable attachment means, such as by an adhesive.

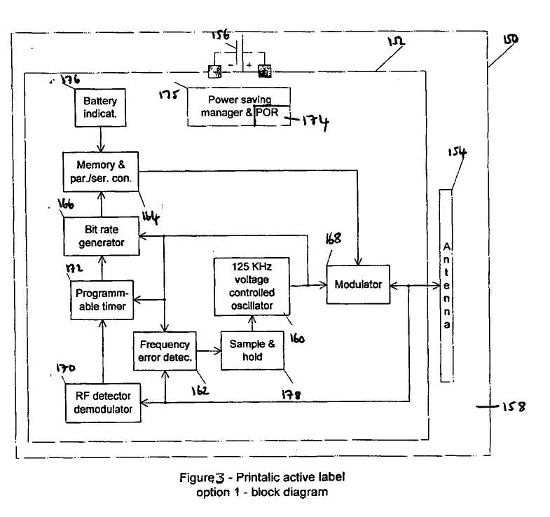

Referring to FIGS. 2a,b,c, in some embodiments, active capacitive transponder 102, includes electronic circuitry for RFID transponder application configured for active capacitive coupling 108, at least one antenna 110 and at least one power source 112. In some embodiments, such as in FIG. 2a, active capacitive transponder 102 includes a substrate base layer 114, which can accommodate the transponder components. In some embodiments the transponder 102 components or some of the transponder components are disposed on the tracked object or packaging of the tracked object and are not disposed on an independent substrate base layer 114.

FIG. 2c shows an embodiment of an active capacitive transponder 102a, wherein antenna 110 is disposed directly on the tracked object or packaging of object 116. As can be seen from FIG. 2b, the at least one power source 112 and electronic circuitry 108 are disposed on a substrate 103. Substrate 103 may include an interposer 103. An interposer is an intermediate attachment mechanism. One non-limiting example of an interposer is a paper label with printed ink electrode stems connected to the RFID silicon for facilitating easy attachment of IC 108 to the transponder 102a. Power source 112 can also be attached to interposer 103 to form a device 115, which is referred to herein as a powerposer 115. Connection between powerposer 115 and antenna 110 and connection of electronic circuitry (IC) 108 to interposer 103 is non-critical. The embodiment of the transponder illustrated in FIG. 2c is also shown in FIG. 1.

The active transponder 102 components may optionally be integrated in any suitable combination and may be disposed on substrate base layer 114 in any suitable way. In some embodiments, at least one antenna can be printed using a carbon/graphite ink using any suitable printer. In some embodiments, at least one antenna 110 can be printed simultaneously with the printing of the graphics of a package or object (not shown in figure) to be tracked.

In some embodiments electronic circuitry 108 is an integrated circuit chip IC, such as an ASIC. In some embodiments, electronic circuitry 108 can be an organic polymer chip, as known in the art. Such a polymer chip is printable. The use of such a chip can facilitate production of a fully printable transponder, in which the battery, connectors, antenna and chip can be printed.

Active transponder 102 can optionally include any suitable number of IC's 108, antenna 110 and power source 112.

A code comprising information relating to package (not shown in figure) and/or to transponder 102 can be generated and stored in a memory of transponder 102. Generally speaking, the code comprises any information that is to be transmitted from transponder 102 to reader 104. For example, the information may comprise an ID number that identifies package. The code may comprise any other data that should be transmitted to reader 104.

FIG. 1 shows a top conductive surface 116 and a bottom conductive surface 118 which are configured as reader antennas. Reader 104 can have one or a plurality of antennas. In one embodiment, the reader antenna is a conductive material included along a surface, such as a shelf or in a lining of the surface on which the tracked objects with attached transponders are stored.

In one non-limiting example of a shelf application, the reader antenna can be a dipole antenna as shown in FIG. 1.

In some embodiments (not shown in FIG. 1), tracked objects are not stacked in order to optimize the range of the system 100.

The transponder 102 may receive power from the power source 112 or in an embodiment wherein the transponder comprises a powerposer 115 from the powerposer 115 and transmit code via its antenna 110 to the reader antennas 116, 118. The reader 104 may receive the transmitted code from its antennas 116, 118 and then transmit the received code to the processing unit 106 for further processing. Conversely, the reader 104 may transmit signals via its antennas 116, 118 to the transponder's antenna 110. The transponder 102 may receive the signals from its antenna 110 and process the received signals.

In some embodiments, such as in an example wherein the transponder 102 is attached to a product on a shelf, the reader 104 can call the transponder 102 periodically for the transponder 102 to report its identification number via the reader 104 to processing unit 106, facilitating checking of current inventory of all shelf products. By checking the inventory “rate of change” of the individual products, the processing unit 106 may alert an operator in cases of for example “low inventory” or “unusual high/low demand.” The system of the present invention 100 may be configured to identify fraud or theft by comparison of the inventory out flow and payments for sales.

In some embodiments the system as described in FIG. 1 can operate on the 125 KHz or the 13.5 MHz RFID band.

System 100 may comprise a shelf item tracking system for example for consumer packaged goods, food products and manufacturing. An additional exemplary application of the system of the present invention 100 is for slow moving items on a conveyer. The cost of using a capacitive coupling RFID system for slowly moving items on a conveyer, is significantly lower than using an inductive coupling RFID system.

1.1 Transponder

FIG. 3 shows one embodiment of a transponder 150 of the present invention. As described above, transponder 150 can comprise at least one integrated circuit 152, at least one antenna 154 and at least one power source 156, which can be optionally disposed on at least one base layer substrate 158.

In some embodiments, transponder 150 can include at least one powerposer and at least one antenna 154. In such embodiments, at least one antenna 154 is not disposed on the base layer substrate 158 on which the IC 152 and power source 156 are disposed. In some embodiments the at least one integrated circuit 152, at least one antenna 154 and at least one power source 156 are interconnected, for example by low cost conductive ink. The interconnection can be in any desired physical configuration.

1.11 Integrated Circuit

In some embodiments the at least one integrated circuit 152 can include a plurality of modules such as, but not limited to a local oscillator 160, frequency error detector and frequency control circuit 162, sample and hold circuit 178, serial read only and read/write memory 164, bit rate generator 166, modulator 168, RF detector/demodulator 170, programmable timer 172, an energy saving module 175, power on reset (POR) circuit 174 and a battery level indicator 176.

Optionally IC can include other components (not shown in FIG. 3), such as but not limited to environmental sensors, an analog to digital converter, a real time clock, a tamper switch, a motion switch, authentication means and a combination thereof.

The oscillator 160 may be an integrated resistor capacitor (RC) oscillator, with frequency calibration during or after production and frequency trimming during operation to compensate frequency drift due to battery voltage and ambient temperature variations. The local oscillator carrier frequency may be compared periodically to the reader transmitter carrier frequency and corrected as required. Alternatively, frequency control components such as crystals or saw resonators may be used. However these are bulky and expensive components.

The system of the present invention includes time synchronization between the reader and the labels. As a time reference it is possible to use the local oscillator frequency and divide it as required or alternatively use a separate low frequency oscillator.

One non-limiting frequency control circuit is shown in FIG. 3. The frequency control circuit of FIG. 3 includes a limited frequency range Voltage Controlled Oscillator (VCO) 160, frequency error detector 162 and a sample and hold circuit 178. The frequency error detector 162 may compare the local oscillator frequency with the received carrier frequency from the reader and produces an error signal that is sampled by the sample and hold circuit 178. The output of the sample and hold circuit 178 may adjust the local oscillator frequency until the error detector 162 indicates ‘no error’.

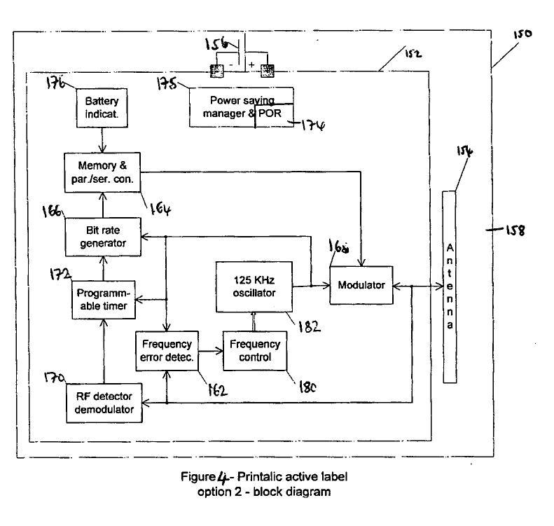

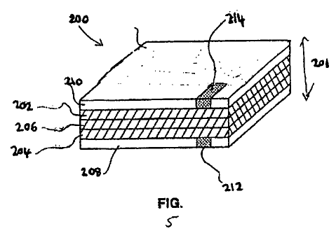

FIG. 4 shows an embodiment of a transponder of the present invention with a different frequency control circuit from that shown in FIG. 3. In FIG. 4, the frequency control circuit 180 comprises a fixed frequency RC oscillator with a bank switched resistor for frequency adjustment 182. The frequency error detector 162 may select the resistor combination until the frequency error is below a preset value.

The RF detector/demodulator 170 may identify the reader transmission for frequency adjustment and synchronization and in turn activate the frequency error detector 162 or set the programmable timer 172 for the next active state session. These two functions may be integrated in one circuit or may share some components.

The data rate generator 166 may divide the local oscillator frequency by 16 for Manchester or Miller coding of the data.

The memory module 164 may comprise a read only ID and header memory, cyclic redundant checksum (CRC) generator, an operational read/write memory and a parallel to serial converter.

The modulator 168 may include the Manchester or Miller data encoder and may use any desired modulation technology, such as, but not limited to ASK, FSK or PSK.

The POR 174 may reset all logic circuits when power is applied and before every active session.

The energy saving module 175 may activate and deactivate the various components of the integrated circuit as required in order to reduce the energy consumption from the internal power source 156 and extend the battery life. The main power saving in the system of the present invention is the periodic sleep wake-up cycle described hereinbelow. In some embodiments, the energy saving module may control the operational modes of the transponder 150 responsively to predetermined time-out conditions, to further reduce energy consumption.

In some embodiments, IC 152 comprises a real-time clock (RTC) (not shown in figures). In some embodiments, the transponder reads the RTC and adds a time-stamp to the code sent to the reader. Optionally, transponder may sense one or more local conditions using one or more external sensors (not shown in figures). For example, sensors may sense the temperature or other environmental conditions in the vicinity of transponder 150. In some embodiments, IC 152 comprises an analog to digital converter (ADC) (not shown in figures) which samples the outputs of the analog sensors and provides the sampled values to the control circuit. In some embodiments, the information of sensors and RTC is combined to provide time-dependent alarm conditions.

1.12 Substrate Base Layer

Substrate base layer is optionally any suitable material of any suitable size, color or shape, which may accommodate active capacitive coupling RFID transponder components. In some embodiments, the active RFID label based on capacitive coupling does not need a substrate base layer. In such an embodiment, the label components may be disposed directly on the item or packaging of the item to be tracked. Such an embodiment provides an integrated active RFID transponder based on capacitive coupling.

In some embodiments, substrate base layer is implemented to include attachment methodology, which readily facilitates attaching RFID transponder to an end-product or end-product packaging. Attachment methodologies may include but are not limited to, adhesive, interposer, self adhesive label, hook and loop fastening systems (such as Velcro®), magnetic attachment, suction attachment, ties and combinations thereof.

In some embodiments, substrate base layer may be made from a material, which can be configured as an antenna.

1.13 Power Source

Power source may comprise one or more suitable energy sources, such as a battery. The power source may optionally include circuitry configured to increase or otherwise control the supplied voltage. In some embodiments, battery is a thin battery. In some embodiments, battery comprises at least one thin and flexible battery, such as the batteries produced by Power Paper Ltd. (Petah-Tikva, Israel). Such thin and flexible batteries are described, for example, in U.S. Pat. Nos. 5,652,043, 5,897,522 and 5,811,204, whose disclosures are incorporated herein by reference. Additional details can also be found at www.powerpaper.com. Thin batteries of this sort are typically less than 1 mm thick.

In some embodiments, the transponder power source is typically less than 1 mm thick and has a bending radius of less than 25 mm. In some embodiments, the transponder battery is less than 0.6 mm thick. In some embodiments, the transponder battery has a bending radius of less than 50 mm.

In some embodiments, the thin and flexible battery comprises a first insoluble negative electrode, a second insoluble positive electrode, and an aqueous electrolyte being disposed between the negative electrode and positive electrode. The electrolyte layer typically comprises (a) a deliquescent material for keeping the open cell wet at all times; (b) an electroactive soluble material for obtaining required ionic conductivity; and (c) a polymer for obtaining a required viscosity for adhering the electrolyte to the electrodes. In some embodiments, the two electrode layers and the electrolyte layer are typically arranged in a co-facial configuration. Alternatively, the two electrode layers and the electrolyte layer may be arranged in a co-planar configuration. The resulting battery can facilitate an even thinner transponder.

In other embodiments, battery may comprise a thin and flexible battery, such as described in US Patent Application Publication 20030165744 A1, whose disclosure is incorporated herein by reference.

Optionally, power source may be disposed on substrate base layer in any suitable way, such as but not limited to welding, crimping, gluing and printing. In some embodiments power source is in close proximity to ASIC and is connected by connection means to ASIC. Power source may be attached to substrate base layer or may optionally be an integral part of substrate base layer, such as in an embodiment wherein power source is printed directly onto substrate base layer. Alternatively, power source can be printed onto a device component, such as but not limited to onto or in the same plane as antenna, ASIC or a combination thereof.

In some embodiments, power source is active all the time with a plurality of different levels of power drain. In some embodiments, battery may be kept in an inactivated state in order to increase the longevity of the battery. Such a case may be desirable for a transponder, which has been manufactured, but is not yet in use. Any suitable method of facilitating an inactivated state may be used, such as but not limited to use of a tab over the battery.

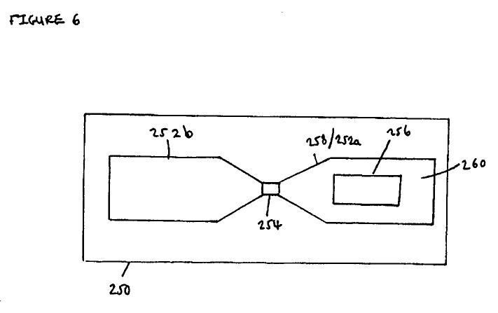

FIG. 5 illustrates a schematic representation of an exemplary power source 200 in accordance with an embodiment of the invention. In some embodiments, power source 200 is thin and flexible. The term “power source” as used herein includes, but is not limited to, any suitable cell in which chemical energy is converted to electric energy by a spontaneous electron transfer reaction. The term includes cells with non-spontaneous reactions, galvanic cells, electrolytic cells, and/or a combination thereof. In the embodiment of FIG. 5, the power source is depicted as an electrochemical cell. The thickness 201 of the electrochemical cell 200 may be up to about 4 mm, in some embodiments up to about 2 mm and in some embodiments up to about 1 mm.

In one embodiment, electrochemical cell 200 includes a positive pole layer 202, a negative pole layer 204, and an electrolyte layer 206 interposed therebetween. In some embodiments, electrochemical cell 200 includes one or more additional conductive layers 208 and 210 to improve the conductivity of pole layers 202 and 204. Suitable conductive layers 208 and 210 are in some embodiments made from any suitable conductive material, such as carbon, graphite, silver, platinum or gold or combinations thereof. In some embodiments conductive layers (current collectors) 208 and 210 are graphite or carbon based layers, which can be printed or applied in any suitable way to cell 200. Examples of graphite and carbon based layers include graphite or carbon webs, sheets, inks and cloth. In some embodiments, electrochemical cell includes negative terminals 212 and positive terminals 214, which are in contact with the corresponding pole layer 204 and 202 or with the corresponding conductive layer 208 and 210 or both. Terminals are made of any suitable material such as, but not limited to, graphite or metal and are in some embodiments applied to cell 200 by a suitable printing technology. Terminals may be located in any desired location of cell 200 and may acquire any suitable shape and size, depending on the specific application. Optionally, terminals may protrude from the surface of cell 200.

In some embodiments, the power source is applied using a suitable printing technique.

1.14 Transponder Antenna

Transponder includes an antenna or an antenna-like element. Antenna-like element is not technically an antenna, although it may look like and may function like an antenna, because there is no TEM. However, an antenna-like element will also be referred to herein as an antenna. Optionally, antenna can be made from any suitable conductive material. In some embodiments, antenna is made from carbon/graphite. In some embodiments, antenna can be made from a conductive polymer. In some embodiments, antenna is printed from conductive inks. In some embodiments, conductive inks are low cost inks. Antenna can be a dipole or a monopole. Optionally, in an embodiment, wherein antenna is a monopole, transponder device can be hand held in order to facilitate a common ground loop. Any suitable common ground connection or coupling to facilitate a ground loop can be used, such as, but not limited to use of a transponder designed for capacitive coupling with a direct or indirect connection (coupling) to common ground. In one non-limiting example, a shelf lining paper is coated with carbon and facilitates antenna function.

Antenna is in some embodiments connected to ASIC, by suitable connection means. In some embodiments, antenna is configured to facilitate receiving electric field signals from a reader and transmitting the electric field signal modulated by the transponder data from the transponder to the reader.

1.141 Integrated Power Source Antenna

In one embodiment of the present invention, an antenna pole may be used as part of power source. Alternatively, part of power source may be used as an antenna pole. Referring back to FIG. 5, as herein previously described, in some embodiments current collector of battery 208, 210 is made from carbon or any other suitable conductive material. As previously stated, in some embodiments, antenna is made from any suitable conductive material, for example a conductive ink, such as carbon. In some embodiments, the present invention provides a device and system, wherein part of, or all of the antenna is the current collector 208 and/or 210 of power source. The present invention also provides a device and system, in which part of the power source, in some embodiments the current collector battery layer, is an antenna pole in the capacitive RFID transponder device.

In some embodiments, power source can be of any size and shape. The power source can be applied or printed directly onto the substrate base layer. Optionally, all layers of the power source, such as the current collector layers, anode and cathode layers and separator layers can be of the same size and shape, or of different sizes and shapes. In one embodiment, current collector layer may be printed or made in any suitable way in the shape of an antenna pole and the other battery layers, such as the negative and positive pole layers and electrolyte layer can be much smaller in dimensions and positioned in any suitable position on the current collector layer.

FIG. 6 shows a schematic drawing of a non-limiting example of a transponder device 250 with a dipole antenna 252, according to one embodiment of the present invention. Integrated circuit 254 is in some embodiments disposed between the two dipole antenna elements 252a,b. In some embodiments, power source 256 includes current collector 258. A conductive layer 252a is applied or printed onto substrate base layer 260 in the shape of one dipole antenna element 252a. Conductive layer 252a is effectively one dipole antenna element 252a and can function as antenna 252. Conductive layer 252a, is also effectively current collector layer 258 of power source 256. The other power source 256 components are printed or applied in any suitable way in smaller dimensions and shape onto the current collector/antenna 258/252a. In some embodiments, power source 256 is connected to integrated circuit 254. In some embodiments, IC 254 is connected by any suitable means to antenna 252 and power source 256.

1.2 System Characteristics

The system of the present invention employs two way SIMPLEX communication, wherein the reader to transponder and transponder to reader communication are executed on separate time slots (i.e. non-simultaneous). As such, the transponder of the present invention is a fully active transponder and includes a carrier frequency generator and a power source to facilitate powering all the transponder circuitry and transmission. Implementation of SIMPLEX communication facilitates a highly sensitive receiver in the reader and use of the same frequency of 125 KHz for the reader to transponder and transponder to reader communication. A fully active capacitive coupling transponder employing SIMPLEX communication of the present invention provides significantly improved range compared to a passive or battery assisted capacitive coupling transponder.

The range of a capacitive coupling communication link as used in the present invention is a function of the area of the transponder and reader antennas. Usually, it is possible to use a reader with relatively large antenna area, but in most applications the area available on the product or package for the transponder antenna is limited.

In a shelf set-up, active transponder of the present invention may be in any suitable orientation, such as with long axis horizontal or long axis vertical or long axis on a slant. In some embodiments transponder is orientated depending on the end-application. In some embodiments, at least a portion of the capacitive coupling transponder of the present invention is bendable and can optionally be bent over a corner of a package. The capacitive coupling transponder of the present invention can tolerate a higher degree of bending or curving than inductive coupling transponders or backscatter transponders.

In some embodiments, the RFID transponder designed or configured for capacitive coupling of the present invention is less than about 1 mm thick and with a suitable surface area. In some embodiments, the RFID transponder device based on capacitive coupling of the present invention is less than about 600 microns thick. In some embodiments, the power source capacity or life expectancy is directly proportional to the thickness of the power source. These factors are taken into consideration in the design of the transponder. In some embodiments, the RFID transponder configured for capacitive coupling of the present invention is flexible, with a bending radius of about 50 mm or less. In some embodiments, RFID transponder label device based on capacitive coupling can operate in varying conditions of temperatures and humidity. In some embodiments, RFID transponder is configured to operate at a temperature range of from about −20° C. to about 60° C. In some embodiments, transponder can operate in a humidity range of from about 5% to about 95% non-condensing. In some embodiments, the reading range of RFID system of the present invention is up to about 1 meter depending on conditions. The system of the present invention is configured to facilitate a write range of up to about 1 meter. Optionally, reader can be stationary or mobile. In some embodiments, reader is stationary.

The transponders of the present invention are operable even when substrate base layer or part of antenna is folded, has holes or is torn.

Optionally, active RFID transponders can be in any design or form. In some embodiments, transponder is in the form of a label. However, the same basic design can be used in different types of transponders.

The RFID transponder and system based on capacitive coupling can be used side by side with a plurality of existing systems, for example it can be used in conjunction with existing bar code systems. In one non-limiting example the RFID transponder based on capacitive coupling can be printed onto the reverse side of a paper label with human readable and bar code information on the other side.

The system and device of the present invention is suitable for numerous applications, such as to monitor shelf items or items on a conveyor.

The transponder of the present invention is advantageous over the inductive transponders of the art. The capacitive coupling transponder is a low cost transponder compared to the inductive coupling transponders. In some embodiments, the antenna of a transponder of the present invention can be made from low cost conductive inks, such as low cost graphite/carbon inks and can be printed directly on any non-conductive product container. In some embodiment of the present invention, low cost conductive ink may be used to connect the circuitry to the antenna. In some embodiments, an interposer technique can be used to place the integrated circuit on the antenna in a simple, non-accurate and low cost process. In some embodiments the shape and size of the antenna and the location of the transponder circuit relative to the antenna is not critical. As such a common substrate for the antenna and the IC is not required and the assembly process can be tailored to a specific product. In contrast, for inductive coupling and backscatter transponders, the size and shape of the antenna and the relative placement of the circuitry are extremely critical and high quality conductive ink and accurate placement equipment must be used.

1.3 Transponder Production

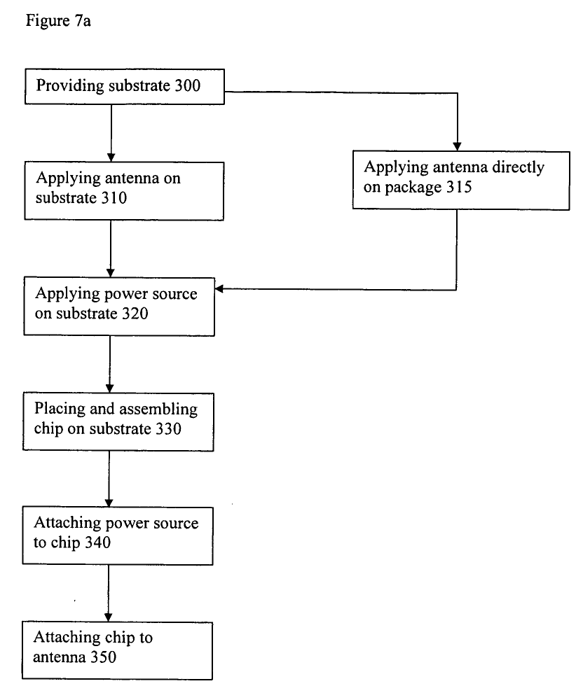

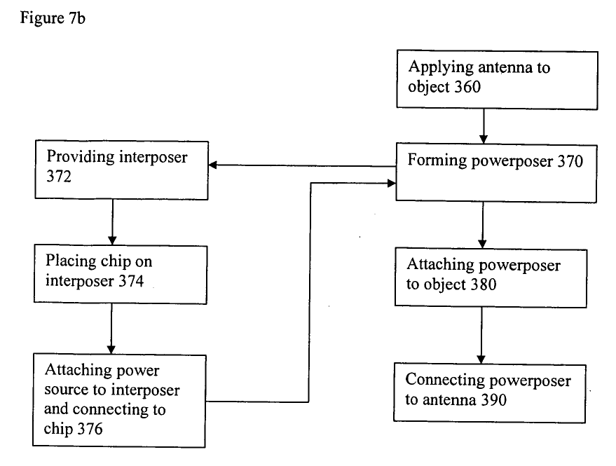

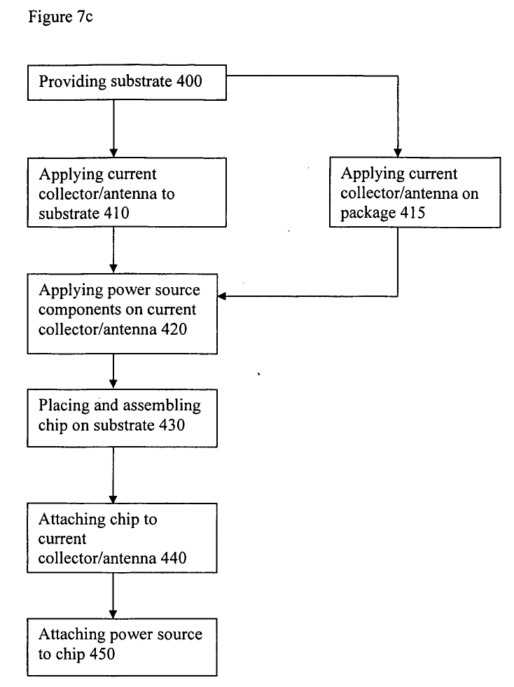

FIG. 7a shows a flow diagram of one method of production of an active RFID transponder based on capacitive coupling according to one embodiment of the present invention.

A substrate is provided (300). In some embodiments, at least one antenna element may be applied onto the substrate (310) using any suitable technique. In some embodiments, antenna may be applied using a printing or etching technique. In some embodiments, antenna may be a layer of conductive carbon ink. In some alternative embodiments, antenna may be applied directly onto package to be tracked (315).

In some embodiments, power source may be applied (320) using any suitable technique, such as a printing technique onto the substrate.

Chip may be placed on the substrate and assembled by any suitable technique (330), such as, but not limited to flip chipping. Battery may be connected to chip (340) using any suitable connection methodology. Chip may be attached to antenna (350) by any suitable technique such as flip chipping. Methodologies of connection may include, but are not limited to, printed conductive ink connections, wiring, etched copper or aluminum conductors, foils, or die-cut metals, glues, adhesives, conductive adhesives etc. The order of the steps of the method of the present invention is not limiting and the steps described above are not necessarily executed in this sequence of steps.

FIG. 7b shows a flow diagram of a method of production of an active RFID transponder based on capacitive coupling according to one embodiment of the present invention, wherein the antenna is not disposed on the IC and battery substrate base layer.

Antenna can be applied to substrate or alternatively directly on product or product packaging (360).

A powerposer may be assembled (370). A powerposer may be made by providing an interposer (372). Interposer is configured to facilitate mounting of a capacitive coupling transponder without an independent substrate base layer, directly on the product label or packaging. In such an embodiment chip is placed onto interposer using a suitable technique (374). In some embodiments power source can be applied onto interposer (376) and connected to chip to form powerposer. Powerposer can be facilely and non-accurately attached to and placed on tracked object or on transponder substrate (380) and connected to antenna (390). Relative placement of the IC and antenna is not critical. Connection to antenna can be facilitated by for example inexpensive conductive adhesive.

FIG. 7c shows a flow diagram of a method of production of an active RFID transponder based on capacitive coupling according to an embodiment wherein the current collector of the power source is also configured as the antenna.

A substrate is provided (400). In some embodiments current collector may be applied to substrate (410), in a pattern of an antenna pole element. In an alternative embodiment, current collector may be applied directly to package (415). In some embodiments, power source or power source components may be applied (420) on current collector in any suitable dimensions and shape, which may be smaller and in a different shape than the current collector dimensions and shape. In some embodiments, power source may be applied using a printing technique. Chip may be placed on substrate and assembled by any suitable technique (430), such as, but not limited to flip chipping. Chip may be attached to current collector/antenna (440) by any suitable technique such as flip chipping. Battery may be connected to chip (450) using any suitable connection methodology.

A fully printed transponder is achievable.

In some embodiments the transponder device may be activated and tested. In some embodiments, an outer lamination may be applied. Optionally, ID may be written into memory.

Active RFID device based on capacitive coupling according to one embodiment of the present invention may be manufactured using a continuous, fully-automated, printing, drying and laminating process. Conductors, antenna, contacts (e.g. adhesives, soldering, crimping), lamination and power source, may be screen printed or painted as paste using thick-film printing processes. A preferred production process for manufacturing devices according to the present invention is a roll-to-roll process. Such a roll-to-roll process may be capable of efficiently mass-producing active RFID devices according to the present invention.

2.0 Communication Protocol

The system of the present invention can operate using a reader talks first (RTF) protocol in a shelf application.

The system of the present invention may be configured to read multiple stationary tags, for example about 1000 in a relatively long time period of about 3 minutes or to read slow moving items on a conveyer. The system of the present invention in some embodiments may include anti-collision protocols and methods in order to enable reading of multiple unregistered items. However once registration is completed, there is no problem of collision.

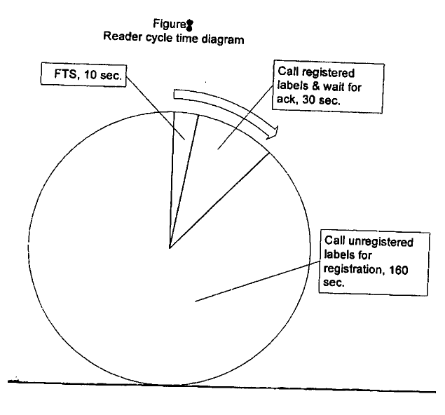

The reader can transmit a 200 second repetitive cycle, comprising a Frequency and Time Synchronization (FTS) signal followed by a sequential call and acknowledgment of all registered labels followed by a call for registration of all unregistered labels. FIG. 8 shows a time diagram of the reader cycle.

The FTS signal can include a period of un-modulated 125 KHz signal for frequency correction of the labels local oscillator, followed by a time code signal for labels time synchronization. The total time of the FTS signal is about 10 seconds. After transmitting the FTS signal, the reader can call sequentially all the registered labels by their (terminal identification) TID number. Each called label can respond with acknowledgment (ACK) code. Since this procedure follows the FTS, timing errors between the reader and the labels are minor. [call−ack]cycle+time margins may be about 30 ms per label or about 30 seconds for 1,000 labels.

The probability of collision is a function of the number of unregistered label calls and the number of reader cycles. Table 1 below shows the probability in some typical cases:

TABLE 1
Probability of collision

| Number of non- | | Expected number | Probability of |
|---|---|---|---|
| registered calls | Reader cycles | of collisions (avrg) | collision |
| 100 | First | 8 | 0.08 |
| | Second | 0 | 0.007 |
| 500 | First | 208 | 0.42 |
| | Second | 36 | 0.17 |
| | Third | 1 | 0.03 |
| | Fourth | 0 | 0.0008 |
| 1,000 | First | 840 | 0.84 |
| | Second | 588 | 0.7 |
| | Third | 288 | 0.49 |
| | Fourth | 69 | 0.24 |
| | Fifth | 4 | 0.06 |
| | Sixth | 0 | 0.003 |

Table 1 shows that with 100 unregistered labels, in most cases all unregistered labels will be registered after the second reader cycle; with 500 unregistered labels, about four reader cycles may be required; and with 1,000 unregistered labels about 6 reader cycles (1000 seconds) may be required.

After the completion of the [call−ack] dialog with all registered labels, the reader may transmit a command to all unregistered labels to select a random time delay between 1 and 160 seconds with about 0.1 seconds increment steps. Each label can select one out of 1,590 possible time delay values. Each label can transmit its TID to the reader at the elapse of the selected time delay.

During the next “Call registered labels & wait for ack” period, the reader can call all the newly received TID (labels) and wait for an “ack.” After calling a specific label and receiving an “ack”, the reader can consider this specific label as “registered” and can transmit the appropriate “operate/sleep” duty cycle during the next “Call registered labels & wait for ack” period.

The label life expectancy is a function of the battery capacity and the “operate/sleep” duty cycle. The “operate/sleep” duty cycle can be selected according to the desired inventory updating rate and the desired label battery life. A 10 mA-h battery is sufficient for about 10 weeks of operation with once every about 200 seconds inventory update rate (the highest rate with 1000 items per reader). The same battery is sufficient for about 50 weeks of operation with once every about 1000 seconds (about 17 minutes) inventory update rate (“operate/sleep” duty cycle of 1/5).

The “operate/sleep” duty cycle also determines the full inventory delay time. With continuous operation the average delay time for full inventory is about 100 seconds (maximum 200 seconds) and for “operate/sleep” duty cycle of 1/5, the average delay time for full inventory is about 600 seconds (maximum 1,200 seconds).

### EXAMPLE

Reference is now made to the following example, which together with the above descriptions, illustrate the invention in a non-limiting fashion. The following example shows the performance that the RFID system of the present invention is at least capable of achieving, set by the 125 KHz band.
Low data rate: 3,906 bits/sec
Low data capacity protocol: 8 bits header, 24 bits ID and 16 bits CRC
Low read rate: 25 labels/sec
   The system can operate acceptably at at least the above low performance level. Higher performance is also possible.

It will be appreciated by persons skilled in the art that the present invention is not limited to what has been particularly shown and described herein. Rather, the scope of the present invention is defined by the appended claims and includes both combinations and subcombinations of the various features described herein as well as variations and modifications thereof which would occur to persons skilled in the art upon reading the foregoing description. Accordingly, it is intended to embrace all such alternatives, modifications and variations that fall within the spirit and broad scope of the appended claims. Also it is to be understood that the phraseology and terminology employed herein is for the purpose of description only and should not be regarded as limiting.

What is claimed is:

1. An active capacitive coupling RFID system, comprising:
(a) at least one reader, wherein the reader is configured to transmit modulated or unmodulated RF electrical signals and to receive and decode data transmitted by a transponder;
(b) at least one active capacitive coupling RFID transponder comprising:
(i) at least one integrated circuit, which is arranged to store a code comprising information and which is configured to generate, modulate and to transmit an RF carrier on LF or HF RFID frequency that comprises the stored code to the reader on a capacitive coupled communication channel;
(ii) at least one antenna configured to receive electric signal via capacitive coupling from the at least one reader, and transmit the transponder code comprising information; and
(iii) at least one power source for providing energy to the at least one integrated circuit and the transponder transmission; and
(c) at least one data processing device for processing the data received from the reader.

2. The active capacitive coupling RFID system of claim 1, wherein the system is configured for SIMPLEX two way communication, wherein the two way communication is not simultaneous.

3. The active capacitive coupling RFID system of claim 1, wherein the SIMPLEX communication link operates on a single frequency.

4. The active capacitive coupling RFID system of claim 1, wherein the transponder further comprises a carrier frequency generator.

5. The active capacitive coupling RFID system of claim 4, wherein the carrier frequency generator is configured to facilitate correction of frequency error in comparison to the reader transmitter carrier frequency.

6. The active capacitive coupling RFID system of claim 1, wherein the at least one power source is a thin and flexible power source.

7. The active capacitive coupling RFID system of claim 1, wherein the at least one antenna comprises carbon/graphite.

8. The active capacitive coupling RFID system of claim 1, wherein at least one of the power source, antenna and IC is made by a printing technique.

9. The active capacitive coupling RFID system of claim 1, wherein the active capacitive coupling RFID transponder device is disposable.

10. The active capacitive coupling RFID system of claim 1, wherein the active capacitive coupling RFID transponder device further comprises a substrate base layer.

11. The active capacitive coupling RFID system of claim 1, wherein the integrated circuit is connected to the at least one antenna and the at least one power source by connection means.

12. The active capacitive coupling RFID system of claim 1, wherein the active capacitive coupling RFID transponder device is a fully or partially printed device.

13. The active capacitive coupling RFID system of claim 1, further comprising at least one conductive surface configured as a reader antenna.

14. The active capacitive coupling RFID system of claim 1, wherein the reading range of the reader is up to about 1 meter.

15. The active capacitive coupling RFID system of claim 1, wherein the transponder device is thin and flexible.

16. The active capacitive coupling RFID system of claim 1, wherein at least one active capacitive coupling RFID transponder device is a plurality of transponder devices.

17. The active capacitive coupling RFID system of claim 1, wherein the reader is a multi-tag reader.

18. The active capacitive coupling RFID system of claim 1 for use in at least one of monitoring shelf items and items on a conveyer.

19. An active capacitive coupling RFID transponder device based on capacitive coupling, comprising:
(a) at least one integrated circuit, which is arranged to store a code comprising information and which is configured to generate, modulate and to transmit an RF carrier on LF or HF RFID frequency that comprises the stored code to the at least one reader on a capacitive coupled communication channel;
(b) at least one antenna configured to receive electric signal via capacitive coupling from the at least one reader, and transmit the transponder code comprising information; and
(c) at least one power source for providing energy to operate the at least one integrated circuit and the transponder transmission.

20. The active capacitive coupling RFID device of claim 19 further comprising a carrier frequency control circuit for controlling carrier frequency according to the reader carrier frequency.

21. The active capacitive coupling RFID device of claim 19, wherein the device is thin and flexible.

22. The active capacitive coupling RFID transponder device of claim 19, wherein the device further comprises a substrate base layer.

23. The active capacitive coupling RFID transponder device of claim 22, wherein the substrate base layer is paper.

24. The active capacitive coupling RFID transponder device of claim 19, wherein the device is integrally formed with an object or packaging.

25. The active capacitive coupling RFID transponder device of claim 19, wherein the at least one IC and the at least one power source are disposed on a base layer and the at least one antenna is disposed directly on an object or packaging.

26. The active capacitive coupling RFID transponder device of claim 22, wherein the substrate base layer comprises an interposer.

27. The active capacitive coupling RFID transponder device of claim 19, wherein the at least one power source is at least one electrochemical cell and wherein the at least one electrochemical cell comprises
(a) a first layer of insoluble negative pole;
(b) a second layer of insoluble positive pole; and
(c) a third layer of aqueous electrolyte disposed between the first and second layers and including
(i) a deliquescent material for keeping the electrochemical cell wet at all times;
(ii) an electroactive soluble material for obtaining ionic conductivity; and
(iii) a polymer for obtaining a desired viscosity for adhering the first and second layers to the third layer.

28. The active capacitive coupling RFID transponder device of claim 19, wherein the IC is connected to the antenna and the battery by connection means.

29. The active capacitive coupling RFID transponder device of claim 19 wherein the device is a partially or fully printed device.

30. The active capacitive coupling RFID transponder device of claim 19, wherein the IC is an ASIC comprising a local oscillator, frequency error detector and frequency control circuit, serial read only and read/write memory, bit rate generator and a modulator, RF detector/demodulator and programmable timer, an energy saving module and POR circuit and a battery level indicator.

31. The active capacitive coupling RFID transponder device of claim 30, wherein the frequency control circuit comprises a limited frequency range voltage controlled oscillator, a frequency error detector and a sample and hold circuit wherein the frequency error detector facilitates comparison of the local oscillator frequency with the received carrier frequency from the reader and production of an error signal that is sampled by the sample and hold circuit and wherein the output of the sample and hold circuit facilitates adjustment of the local oscillator frequency until the error detector indicates no error.

32. The active capacitive coupling RFID transponder device of claim 30, wherein the frequency control circuit comprises a frequency error detector and a fixed frequency RC oscillator with a bank switched resistor for frequency adjustment and wherein the frequency error detector can choose the required resistor combination until the frequency error is below a preset value.

33. The active capacitive coupling RFID transponder device of claim 19 further comprising an energy saving manager comprising a periodic sleep/wake-up cycle for facilitating minimizing energy drain of the at least one power source.

34. The active capacitive coupling RFID transponder device of claim 19, wherein the at least one antenna comprises a conductive material and a portion of the conductive material of the at least one antenna is configured to function as part of the at least one power source.

35. The active capacitive coupling RFID transponder device of claim 19, wherein the at least one power source comprises at least one current collector and wherein the at least one current collector of the at least one power source is configured to function as part of the at least one antenna.

36. The active capacitive coupling RFID transponder device of claim 19, wherein the antenna conductive material comprises carbon.

37. The active capacitive coupling RFID transponder device of claim 19, wherein the device further comprises attachment means.

38. An active capacitive coupling RFID transponder device based on capacitive coupling, comprising:
(a) electronic circuitry configured for capacitive coupling RFID transponder application;
(b) at least one conductive ink layer pattern configured to receive an electric field energy signal from at least one reader and transmit the received signal modulated by the transponder data, wherein at least a part of the conductive ink layer pattern is configured to receive the electric field energy signal via capacitive coupling from the at least one reader, transmit the received signal modulated by the transponder data and collect current from an integrally formed power source; and
(c) at least one thin and flexible power source for providing energy to operate the electronic circuitry and the transponder transmission.

39. A battery energy saving system for managing power of an RFID transponder device based on capacitive coupling comprising:
(a) an energy saving module configured to operate the transponder device in registered and unregistered modes; and
(b) at least one timer in communication with the energy saving module to facilitate changing modes from the registered mode to the unregistered mode when the transponder device is not called by a reader for a preset time.

40. An active capacitive coupling RFID system, comprising:
(a) at least one reader, wherein the reader is configured to transmit modulated or unmodulated RF electrical signals and to receive and decode data transmitted by a transponder;
(b) at least one active capacitive coupling RFID transponder comprising:
(i) at least one device comprising:
(1) an interposer comprising a substrate base layer and attachment means;
(2) at least one integrated circuit, which is arranged to store a code comprising information and which is configured for capacitive coupled RFID transponder application; and
(3) at least one power source for providing energy to operate the at least one integrated circuit and transponder transmission, wherein the at least one power source and the at least one integrated circuit are disposed on the interposer substrate base layer; and
(ii) at least one antenna configured to receive the electric signals from the at least one reader and to transmit the transponder code comprising information; and
(c) at least one data processing device for processing the data received from the reader.
